(19) United States
(12) Patent Application Publication
(10) Pub. No.: US 2020/0090269 A1
(43) Pub. Date: Mar. 19, 2020

(54) DATA COLLECTION METHOD AND APPARATUS FOR RISK EVALUATION, AND ELECTRONIC DEVICE

(71) Applicant: ALIBABA GROUP HOLDING LIMITED, Grand Cayman (KY)

(72) Inventors: Fan YANG, Hangzhou (CN); Xin FU, Hangzhou (CN)

(21) Appl. No.: 16/692,153

(22) Filed: Nov. 22, 2019

Related U.S. Application Data
(63) Continuation of application No. PCT/CN2018/088191, filed on May 24, 2018.

(30) Foreign Application Priority Data
May 27, 2017 (CN) 201710387851.X

(51) Int. Cl. G06Q 40/02; G06Q 30/02

(52) U.S. Cl. CPC G06Q 40/025; G06Q 30/0201

(57) ABSTRACT

A method and an apparatus for risk evaluation are disclosed. The method includes: obtaining a set of data types of data to be collected; obtaining, from historical data of the target user collected from historical transactions, data corresponding to one or more of the data types; pushing, to a computing device associated with the target user, a question corresponding to a data type not obtained from the historical data; receiving an answer to the question from the computing device; and determining the obtained data and the received answer as data for risk evaluation of the target user.

### CROSS REFERENCE TO RELATED APPLICATIONS

The present application is a continuation application of the International Patent Application No. PCT/CN2018/088191, filed on May 24, 2018, and titled “DATA COLLECTION METHOD AND APPARATUS FOR RISK EVALUATION, AND ELECTRONIC DEVICE,” which claims priority to Chinese Patent Application No. 201710387851.X filed on May 27, 2017. The entire contents of all of the above applications are incorporated herein by reference in their entirety.

### TECHNICAL FIELD

This application relates to the field of Internet technologies, and in particular, to a method, apparatus, and electronic device for data collection for risk evaluation.

### BACKGROUND

With continuous development of Internet technologies, users are provided with increasingly diverse Internet products such as financial management products.

Generally, to provide a user with a suitable product, it is necessary to carry out risk evaluation for the user to obtain a risk level of the user. In this way, different financial products can be provided according to different risk levels of users. For example, for financial management products, a high-risk high-yield financial product can be provided for a user with a relatively high risk level (indicating that the user can tolerate more risks); and a low-risk low-yield financial product can be provided for a user with a relatively low risk level.

Because risk evaluation requires data closely associated with the user, generally, a questionnaire survey approach is used, where a questionnaire is pushed (through push notification) to the user, and the user fills in data. However, data collected in this manner may be affected by subjective factors of the user, causing a result of the risk evaluation to be inconsistent with an actual situation of the user.

### SUMMARY

A method and an apparatus for risk evaluation are provided in this application, which may at least mitigate the problem that collected data is inaccurate in the prior art.

A risk evaluation method provided according to an embodiment of this application includes: obtaining a set of data types of data to be collected associated with a target user; obtaining, from historical data of the target user collected from historical transactions, data corresponding to one or more of the data types; pushing, to a computing device associated with the target user, a question corresponding to a data type not obtained from the historical data; receiving an answer to the question from the computing device; and determining the obtained data and the received answer as data for risk evaluation of the target user.

A risk evaluation method provided according to an embodiment of this application includes: obtaining a set of data types of data to be collected associated with a target user; obtaining, from historical data of the target user collected from historical transactions, data corresponding to one or more of the data types; pushing, to a computing device associated with the target user, a question corresponding to a data type not obtained from the historical data; and receiving an answer to the question from the computing device.

A risk evaluation apparatus provided according to an embodiment of this application includes: a set obtaining unit, configured to: obtain a set of data types of data to be collected associated with a target user; a data obtaining unit, configured to obtain, from historical data of the target user collected from historical transactions, data corresponding to one or more of the data types; a question pushing unit, configured to push, to a computing device associated with the target user, a question corresponding to a data type not obtained from the historical data; an answer receiving unit, configured to receive an answer to the question from the computing device; and a data determining unit, configured to determine the obtained data and the received answer as data for risk evaluation of the target user.

A risk evaluation apparatus provided according to an embodiment of this application includes: a set obtaining unit, configured to obtain historical data of a target user; a data obtaining unit, configured to compare the obtained historical data with data types of data to be collected, and determine data types that are not obtained among the data types of the data to be collected; a question pushing unit, configured to push, to a computing device associated with the target user, a question corresponding to a data type not obtained from the historical data; and an answer receiving unit, configured to receive data filled in by the target user.

An electronic device provided according to an embodiment of this application includes: a processor; and a memory configured to store instructions executable by the processor, wherein the processor is configured to: obtain a set of data types of data to be collected associated with a target user; obtain, from historical data of the target user collected from historical transactions, data corresponding to one or more of the data types; push, to a computing device associated with the target user, a question corresponding to a data type not obtained from the historical data; receive an answer to the question from the computing device; and determine the obtained data and the received answer as data for risk evaluation of the target user.

An electronic device provided according to an embodiment of this application includes: a processor; and a memory configured to store instructions executable by the processor, wherein the processor is configured to: obtain a set of data types of data to be collected associated with a target user; obtain, from historical data of the target user collected from historical transactions, data corresponding to one or more of the data types; push, to a computing device associated with the target user, a question corresponding to a data type not obtained from the historical data; and receive an answer to the question from the computing device.

A risk evaluation system provided according to an embodiment of this application includes: one or more processors and one or more non-transitory computer-readable memories coupled to the one or more processors and configured with instructions executable by the one or more processors to cause the system to perform operations comprising: obtaining a set of data types of data to be collected associated with a target user; obtaining, from historical data of the target user collected from historical transactions, data corresponding to one or more of the data types; pushing, to a computing device associated with the target user, a question corresponding to a data type not obtained from the historical data; receiving an answer to the question from the computing device; and determining the obtained data and the received answer as data for risk evaluation of the target user.

A non-transitory computer-readable storage medium for risk evaluation provided according to an embodiment of this application is configured with instructions executable by one or more processors to cause the one or more processors to perform operations comprising: obtaining a set of data types of data to be collected associated with a target user; obtaining, from historical data of the target user collected from historical transactions, data corresponding to one or more of the data types; pushing, to a computing device associated with the target user, a question corresponding to a data type not obtained from the historical data; receiving an answer to the question from the computing device; and determining the obtained data and the received answer as data for risk evaluation of the target user.

In the embodiments of this application, by using historically recorded data of a target user, a part or all of data to be collected is obtained from the historical data. Data that is not collected may still be provided by the target user in the form of questionnaires. In this way, data that is automatically obtained based on the historical data of the target user is relatively authentic. Therefore, an evaluation result deviation caused by subjective factors of the target user can be corrected by using the automatically obtained data. Moreover, a part or all of the data to be collected is obtained from the historical data automatically, so that questions pushed to the target user can be greatly reduced or even eliminated, thereby avoiding diminishing the experience of the target user.

### BRIEF DESCRIPTION OF THE DRAWINGS

FIG. 1 is a flowchart of a risk evaluation method according to some embodiments of this application.

FIG. 2 is a schematic diagram of a table of various data types of data to be collected, according to some embodiments of this application.

FIG. 3 is a flowchart of a risk evaluation method, according to some embodiments of this application.

FIG. 4 is a hardware structural diagram of a device in which a risk evaluation apparatus according to this application is provided.

FIG. 5 is a schematic diagram of modules of a risk evaluation apparatus according to some embodiments of this application.

FIG. 6 is a hardware structural diagram of a device in which a risk evaluation apparatus according to this application is provided.

FIG. 7 is a schematic diagram of modules of a risk evaluation apparatus, according to some embodiments of this application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with this application. Instead, they are merely examples of apparatuses and methods consistent with aspects related to this application as recited in the appended claims.

The terms used in this application are merely for the purpose of illustrating embodiments, and are not intended to limit this application. The terms “a”, “said”, and “the” of singular forms used in this application and the appended claims are also intended to include plural forms, unless otherwise specified in the context clearly. The term “and/or” used herein indicates and includes any or all possible combinations of one or more associated listed items.

Although terms such as first, second, and third may be used in this application to describe various pieces information, such information should not be limited to these terms. These terms are merely used for distinguishing information of the same type from each other. For example, within the scope of this application, first information may alternatively be referred to as second information, and similarly, second information may alternatively be referred to as first information. Depending on the context, the term “if” used herein may be interpreted as “when . . . ” or “upon . . . ” or “in response to determining”.

As described above, because risk evaluation usually requires data closely associated with the user, usually a questionnaire is directly pushed to the user, and the user fills in data. However, data collected in this manner may be affected by subjective factors of the user, causing a result of the risk evaluation to be inconsistent with an actual situation of the user.

On the other hand, for financial products, it is required in the industry that a comprehensive risk evaluation needs to be performed for each user. Therefore, if data is collected in the form of questionnaires, users may face with dozens or even hundreds of questions, and it takes a long time for them to complete the questions.

The embodiments may be applied to servers, such as a server or server cluster used for risk evaluation, or a cloud platform built based on the server cluster, for example, a server or server cluster for financial management, or a cloud platform built based on the server cluster.

Generally, a user may perform data interaction with the server by using a client. For example, the user purchases a financial management product on a financial management platform by using the client.

In some embodiments, the client may refer to a client device on hardware, for example, a desktop computer, a laptop computer, a tablet computer, a smartphone, a handheld computer, a personal digital assistant (PDA), or any other wired or wireless processor driving apparatus.

The client may refer to a software application client, for example, a financial management application (APP).

The client may also refer to a client combining software and hardware, for example, a smartphone installed with a financial management APP.

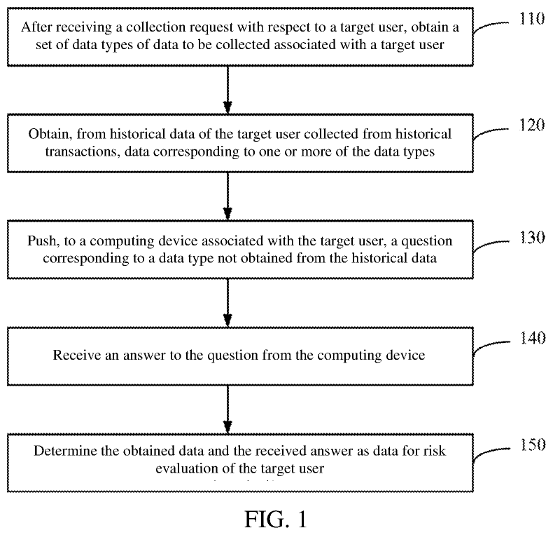

In order to resolve the foregoing problem, referring to FIG. 1, which is a flowchart of a risk evaluation method according to some embodiments of this application, the method includes the following steps 110-150.

Step 110: After receiving a collection request with respect to a target user, obtain a set of data types of data to be collected associated with a target user. In some embodiments, the set of data types may include one or more of the following data types: age, job, income source, annual income, investment fund, financial management experience, financial management time, financing product, investment target, and risk preference.

In some embodiments, the set of data types of data to be collected may be a manually preset set of data types of data to be collected, and each type in the set of data types is a factor that can affect an analysis and evaluation result.

A financial management scenario is used as an example for description. According to requirements of the industry, a comprehensive risk evaluation needs to be carried out for users, and several major investigation dimensions are required. For details, reference may be made to “Administration of the Suitability of Securities and Futures Investors” issued in 2016.

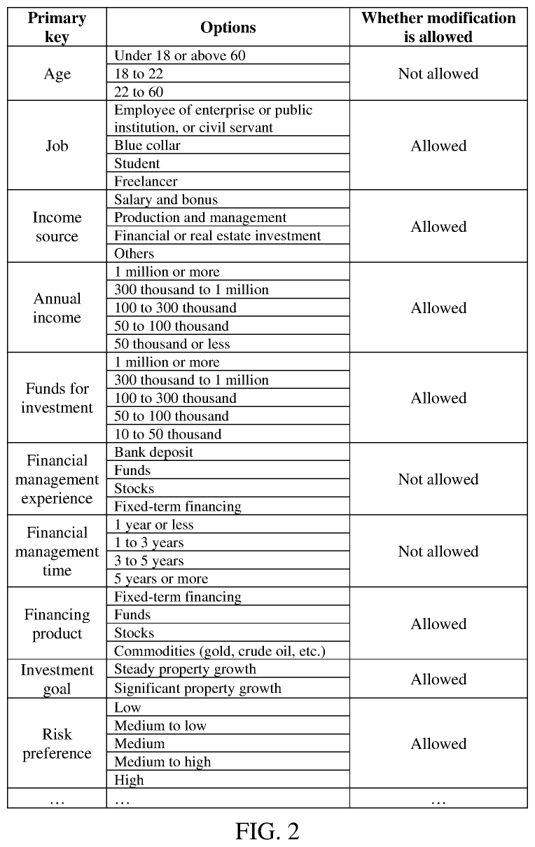

Referring to FIG. 2, it is a schematic diagram of a table of various data types of data to be collected.

As shown in FIG. 2, the set of data types of data to be collected may include:

1: Age, which represents the age of the target user. For example, young people can invest for a long term, and a short-term loss can be recovered through growth in the future. Therefore, young people have a relatively strong risk immunity. Elder people have a high requirement on liquidity of investment funds, and a loss can hardly be recovered through subsequent adjustments. Therefore, elder people have a relatively weak risk immunity.

2: Job, which represents the job category of the target user. For example, a student without an income source may have a relatively weak risk immunity; and an enterprise's senior manager with a high income has a relatively strong risk immunity.

3: Income source, which represents whether the target user has diverse income sources. For example, compared with a user with only a salary income, a user with multiple income sources has a stronger risk immunity.

4: Annual income, which represents the income level of the target user. Generally, a user with a high annual income has a stronger risk immunity than a user with a low annual income.

5: Investment fund, which represents the amount of available funds of the target user for investment. The investment fund can affect financial products recommended to the user, so that financial products suitable for the user to invest are recommended.

6: Financial management experience, which represents financial management channels (for example, bank deposit, funds, stocks, and futures) of the target user. The financial management experience can affect financial products recommended to the user, so that financial products conforming to the financial management experience of the user are recommended.

7: Financial management time, which represents the number of years of financial management experience of the target user.

8: Financial product, which represents the financial products that the target user expects to invest in.

9: Investment target, which represents the expected return value of the target user. Financial products meeting the expected return value can be recommended.

10: Risk preference, which represents the acceptable risk level of the target user. Financial products meeting the risk preference can be recommended.

Notwithstanding, the set of data types of data to be collected may include other suitable data types.

Step 120: Obtain, from historical data of the target user collected from historical transactions, data corresponding to one or more of the data types.

In some embodiments, the historical data is data historically recorded by the target user. For example, if the target user shops on an online shopping platform, identity information of the target user for receiving orders is recorded, such as name, mobile phone number, and home address. For another example, if the target user purchases a financial product on a financial management platform, a preferred financial management channel, an expected return value, and the like of the target user are also recorded.

In another aspect, data such as consumption level and income level of the target user can be calculated based on a model (such as a model constructed based on a machine learning algorithm) according to historical shopping information of the target user. For example, a model for calculating user income level can be constructed by performing model training on data of many users, such as shopping information (e.g., monthly expense) and income level (e.g., monthly income or annual income). Then, the income level of a user can be calculated by merely inputting shopping information of the user to the model.

In another aspect, required data may be further obtained through analysis based on big data. For example, a user usually purchases milk formula, but no data indicates that the user has a child. According to big data analysis, it is found that most users purchasing milk formula have children, and therefore, a relation between milk formula purchase and having children can be constructed. It can be further concluded that the user also has a child.

Step 130: Push, to a computing device associated with the target user, a question corresponding to a data type not obtained from the historical data.

As shown in FIG. 2, questions corresponding to the types are “options”.

For example, assuming that the type “income source” is not obtained, the questions, that is, the “options”, corresponding to the type “income source” shown in FIG. 2 may be pushed to the target user: 1: salary and bonus; 2: production and management; 3: financial or real estate investment; 4: others.

All the contents shown in FIG. 2 are merely examples. Questions corresponding to types may be any content preset manually, and specific questions are not limited in this application.

Generally, pushing to the target user may be pushing to a reserved email or mobile phone number of the target user; or pushing to an application program client used by the target user.

In some embodiments, because not all data that needs to be collected can be collected from the historical data of the target user, a question corresponding to a data type not obtained from the historical data further needs to be pushed to a computing device associated with the target user, so that the target user may fill in the data.

Each target user may have different historical data, and data that matches the set of data types and can be obtained from the historical data is different. Therefore, missing types (that is, types that have not been obtained) are also different, and as a result, pushed questions may also be different. For example, for a user with a relatively large amount of historical data, there may be fewer missing types, and fewer questions are pushed, or even all data types of data can be obtained from the historical data, and in this case, it is unnecessary to push any question. For a user with a relatively small amount of historical data, there may be more missing types, and more questions are pushed, or even none of the types of data can be obtained from the historical data, and in this case, questions corresponding to all the data types need to be pushed. Such personalized questions are more flexible and more efficient.

Step 140: Receive an answer to the question from the computing device.

After receiving the question pushed by the server, the target user can fill in a corresponding answer according to the actual circumstance, and may upload the answer filled in. As described above, each answer corresponds to one question. In order to enable the server to identify which answer corresponds to which question, each uploaded answer may carry the corresponding question or a corresponding question identifier. In this way, after receiving an answer to the question from the computing device, the server can determine which type of to-be-collected data that the answer belongs to based on the questions or question identifiers, and based on a correspondence between the types of data to be collected and the questions, or a correspondence between the types of data to be collected and the question identifiers.

The answers uploaded by the target user may also be recorded into the historical data of the target user. In this way, the answers can be used by other systems calling the historical data.

For example, during the first risk evaluation for the target user, data of three types {A, B, C} in a set of data types {A, B, C, D} is obtained from historical data of the target user collected from historical transactions, and finally the target user fills in an answer of the type D. The server records the answer of the type D into the historical data of the target user.

During the second risk evaluation for the target user, it is assumed that the set of data types is still {A, B, C, D}. Because the answer of the type D has been added to the historical data during the first risk evaluation, data of all the types {A, B, C, D} can be obtained from the historical data of the target user during the second risk evaluation process, and the target user does not need to answer the question of the type D again.

During the second risk evaluation for the target user, it is assumed that the set of data types is updated to be {A, B, C, D, E}, and there is no data of the type E in the historical data of the target user. Similarly, because the answer of the type D has been added to the historical data during the first risk evaluation, the user just needs to answer questions of the type E during the second risk evaluation process, and does not need to answer both the questions of the types D and E.

By adding the answer to the question from the computing device to the historical data, data that is missing before can be supplemented.

Step 150: Determine the obtained data and the received answer as data for risk evaluation of the target user.

According to the data obtained from the historical data and the answer filled in by the target user, risk evaluation can be performed after the user confirms that the data and the answer are correct.

According to the embodiments of this application, by using historically recorded data of a target user, a part or all of data to be collected is obtained from the historical data. Data that is not collected may still be provided by the target user in the form of questionnaires. In this way, data that is automatically obtained based on the historical data of the target user is relatively authentic. Therefore, an evaluation result deviation caused by subjective factors of the target user can be corrected by using the automatically obtained data. Moreover, a part or all of the data to be collected is obtained from the historical data automatically, so that questions pushed to the target user can be greatly reduced or even eliminated, thereby avoiding diminishing the experience of the target user.

The historical data of the target user in the embodiments of this application may be offline historical data. In this way, in a process of calling the historical data of the target user, normal operations of online services are not affected because the data is offline. Moreover, offline data has a higher calculation efficiency. For example, the offline data is cached in advance, and does not need to be downloaded temporarily.

In an actual application process, the historical data of the target user needs to be used, and the historical data of the target user usually relates to the personal privacy of the target user. Accordingly, in some embodiments of this application, based on the embodiment shown in FIG. 1, the method may further include the following step before step 120: determining whether the target user authorizes use of the historical data; and step 120 includes: obtaining, from the historical data of the target user, the data corresponding to the one or more of the data types when the target user authorizes use of the historical data.

In some embodiments, whether the historical data can be used may depend on authorization by the target user. The server is allowed to obtain, from the historical data of the target user, the data corresponding to the one or more of the data types after the target user authorizes the server to use the historical data.

In the case where the target user does not authorize the use of the historical data, because the server cannot use the historical data of the target user, step 120 cannot be performed. Therefore, in step 130, the type that is not obtained includes all of the data types.

That is, when the target user does not authorize use of the historical data, step 130 includes: pushing, to a computing device associated with the target user, questions corresponding to all data types in the set of data types of data to be collected.

In some embodiments of this application, after step 120, the method further includes: pushing the obtained data to the target user; and step 150 includes: when receiving a confirmation that the obtained data is correct from the target user, determining the obtained data and the received answer as the data for risk evaluation of the target user.

In some embodiments, because some of the data automatically obtained by the server is obtained through analysis and calculation based on the historical data and does not necessarily reflect the real situation of the user, in order to avoid mistakes, all the obtained data may be pushed to the target user. The obtained data is ultimately used, that is, determined as the data for risk evaluation of the target user, after the target user makes a confirmation.

In some embodiments of this application, the data types of the data to be collected include modifiable data and non-modifiable data; and

the target user is allowed to modify the obtained data when the obtained data belongs to the modifiable data.

In some embodiments, the obtained data, that is, the foregoing data obtained from the historical data, is obtained based on the historical data. A part of the obtained data is objective data, for example, whether the target user has purchased any financial product before; such data reflects an absolute fact, and is not allowed to be modified by the target user. Other data is calculated based on a model, for example, the foregoing income level of the target user calculated based on a model according to historical shopping information of the target user. Data about the income level is calculated based on the model, and therefore may be inconsistent with an actual income level of the target user. Therefore, such data is allowed to be modified by the target user.

As shown in FIG. 2, each type has an option of “whether modification is allowed”.

1: Age, which represents the age of the target user, is not allowed to be modified by the target user.

2: Job, which represents the job category of the target user, is allowed to be modified by the target user.

3: Income source, which represents whether the target user has diverse income sources, is allowed to be modified by the target user.

4: Annual income, which represents the income level of the target user, is allowed to be modified by the target user.

5: Investment fund, which represents the amount of available funds of the target user for investment, is allowed to be modified by the target user.

6: Financial management experience, which represents financial management channels of the target user, is not allowed to be modified by the target user.

7: Financial management time, which represents the number of years of the financial management experience of the target user, is not allowed to be modified by the target user.

8: Financial product, which represents the financial product that the target user expects to invest in, is allowed to be modified by the target user.

9: Investment target, which represents the expected return value of the target user, is allowed to be modified by the target user.

10: Risk preference, which represents the acceptable risk level of the target user, is allowed to be modified by the target user.

All of the contents in FIG. 2 are merely examples. Whether each type is allowed to be modified by the target user may be preset manually, and is not limited in this application.

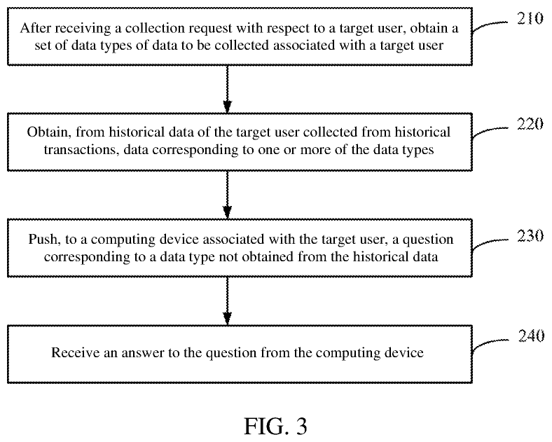

Referring to FIG. 3, it is a flowchart of a risk evaluation method according to some embodiments of this application. The method may include the following steps:

Step 210: After receiving a collection request with respect to a target user, obtain a set of data types of data to be collected associated with a target user;

Step 220: Obtain, from historical data of the target user collected from historical transactions, data corresponding to one or more of the data types;

Step 230: Push, to a computing device associated with the target user, a question corresponding to a data type not obtained from the historical data;

Step 240: Receive an answer to the question from the computing device.

The embodiments are different from the embodiments shown in FIG. 1 in that, the application scenario of the embodiments is not limited to risk evaluation, that is, the embodiments can be applied to any scenario that requires data collection. For the steps in the embodiments, reference may be made to the description about the steps in the embodiments shown in FIG. 1. Moreover, preferred embodiments of the embodiments shown in FIG. 1 may also be used as preferred solutions of the embodiments here. Therefore, related description content is not elaborated again in the embodiments.

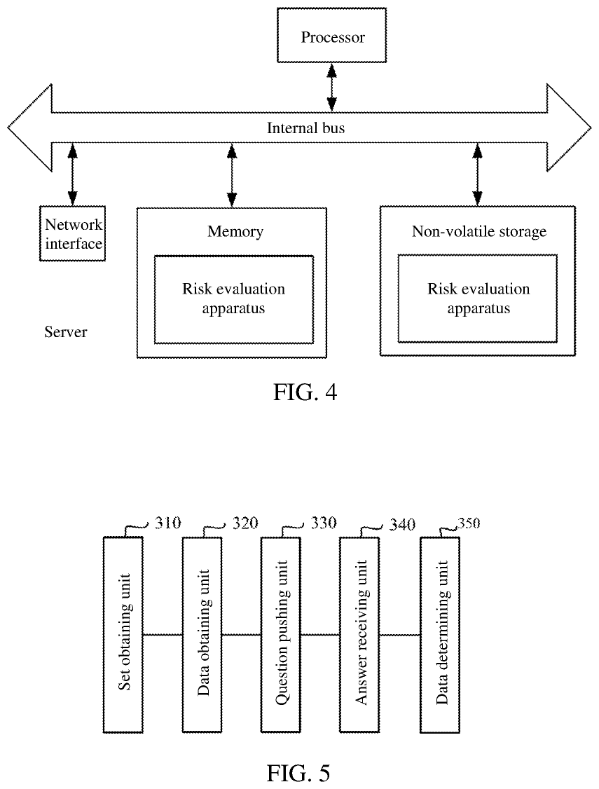

Corresponding to the embodiments of the risk evaluation method illustrated in FIG. 1, this application further provides embodiments of a risk evaluation apparatus. The apparatus embodiments may be implemented by software, hardware, or a combination of software and hardware. Using a software implementation as an example, as a logical apparatus, the apparatus is formed by reading corresponding computer program instructions from a non-volatile storage into a memory by a processor of a device where the apparatus is located. On a hardware level, as shown in FIG. 4, which is a hardware structural diagram of a device in which a risk evaluation apparatus according to this application is provided, the apparatus in the embodiments not only includes a processor, a network interface, a memory, and a non-volatile storage shown in FIG. 4, but usually may also include other hardware according to the actual data collection function for risk evaluation. Details are not described herein again.

Referring to FIG. 5, which is a diagram of modules of a risk evaluation apparatus according to some embodiments of this application, the apparatus includes a set obtaining unit 310, a data obtaining unit 320, a question pushing unit 330, an answer receiving unit 340, and a data determining unit 350.

The set obtaining unit 310 is configured to: obtain a set of data types of data to be collected associated with a target user.

The data obtaining unit 320 is configured to obtain, from historical data of the target user collected from historical transactions, data corresponding to one or more of the data types.

The question pushing unit 330 is configured to push, to a computing device associated with the target user, a question corresponding to a data type not obtained from the historical data.

The answer receiving unit 340 is configured to receive an answer to the question from the computing device.

The data determining unit 350 is configured to determine the obtained data and the received answer as data for risk evaluation of the target user.

In some optional embodiments, before the data obtaining unit 320, the apparatus further includes: a determination unit, configured to determine whether the target user authorizes use of the historical data; and the data obtaining unit 320 is configured to: obtain, from the historical data of the target user, the data corresponding to the one or more of the data types when the target user authorizes use of the historical data.

In some optional embodiments, when the target user does not authorize use of the historical data, the question pushing unit 530 is configured to: push, to a computing device associated with the target user, questions corresponding to all data types in the set of data types of data to be collected.

In some optional embodiments, after the data obtaining unit 320, the apparatus further includes: a data pushing sub-unit, configured to push the obtained data to the target user; and the data determining unit 350 is configured to: when receiving a confirmation that the obtained data is correct from the target user, determine the obtained data and the received answer as the data for risk evaluation of the target user.

In some optional embodiments, the data types of the data to be collected includes modifiable data and non-modifiable data; and the target user is allowed to modify the obtained data when the obtained data belongs to the modifiable data.

In some optional embodiments, the received answer is recorded into the historical data of the target user.

In some optional embodiments, the historical data comprises offline historical data.

In some embodiments, the various modules and units of the data collection or risk evaluation apparatus may be implemented as software instructions or a combination of software and hardware. For example, the risk evaluation apparatus described with reference to FIG. 5 may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules and units described above. In some embodiments, the risk evaluation apparatus may include a server, a mobile phone, a tablet computer, a PC, a laptop computer, another computing device, or a combination of one or more of these computing devices.

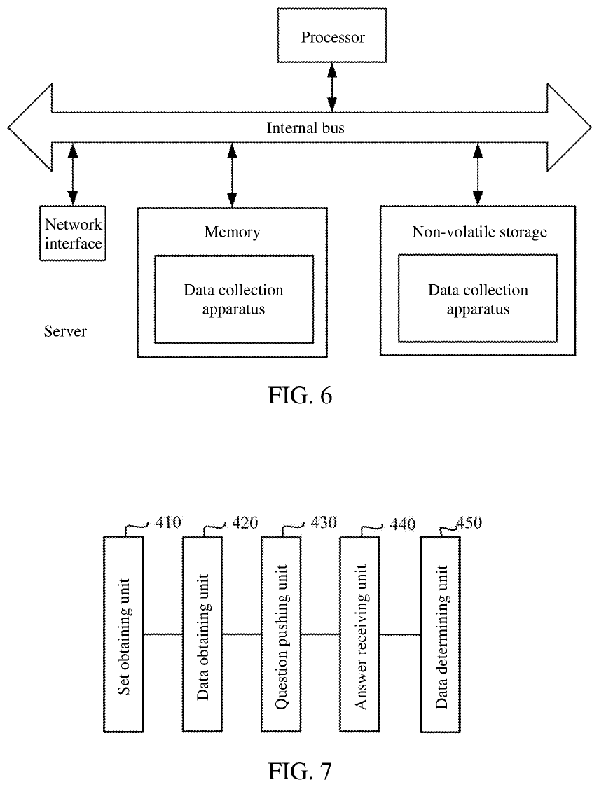

Corresponding to the embodiments of the risk evaluation method illustrated in FIG. 3, this application further provides embodiments of a risk evaluation apparatus. The apparatus embodiments may be implemented by software, hardware, or a combination of software and hardware. Using a software implementation as an example, as a logical apparatus, the apparatus is formed by reading corresponding computer program instructions from a non-volatile storage into a memory by a processor of a device where the apparatus is located. On a hardware level, as shown in FIG. 6, which is a hardware structural diagram of a device in which a risk evaluation apparatus according to this application is provided, the apparatus in the embodiments not only includes a processor, a network interface, a memory, and a non-volatile storage shown in FIG. 6, but usually may also include other hardware according to the actual data collection function. Details are not described herein again.

Referring to FIG. 7, which is a diagram of modules of a risk evaluation apparatus according to some embodiments of this application, the apparatus includes a set obtaining unit 410, a data obtaining unit 420, a question pushing unit 430, and an answer receiving unit 440.

The set obtaining unit 410 is configured to obtain historical data of a target user.

The data obtaining unit 420 is configured to compare the obtained historical data with data types of data to be collected, and determine data types that are not obtained among the data types of the data to be collected.

The question pushing unit 430 is configured to push, to a computing device associated with the target user, a question corresponding to the data type not obtained.

The answer receiving unit 440 is configured to receive data filled in by the target user.

The optional data determining unit 450 may be similar to the data determining unit 350.

In some embodiments, the various modules and units of the data collection or risk evaluation apparatus may be implemented as software instructions or a combination of software and hardware. For example, the risk evaluation apparatus described with reference to FIG. 7 may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules and units described above. In some embodiments, the risk evaluation apparatus may include a server, a mobile phone, a tablet computer, a PC, a laptop computer, another computing device, or a combination of one or more of these computing devices.

The system, the apparatus, the module, or the unit described in the foregoing embodiments can be implemented by a computer chip or an entity or implemented by a product having a certain function. A typical implementation device is a computer, and the form of the computer may be a personal computer, a laptop computer, a cellular telephone, a camera phone, a smartphone, a personal digital assistant, a media player, a navigation device, an email transceiver device, a game console, a tablet computer, a wearable device, or a combination thereof.

The implementation of the functions and effects of the various units in the above-described apparatus is described in detail in the implementation of the corresponding steps in the above-described method and will not be described in detail herein.

The apparatus embodiments substantially correspond to the method embodiments. Therefore, for related parts of the apparatus embodiments, reference will now be made in part to the description of the method embodiments. The apparatus embodiments described above are merely exemplary. The unit as illustrated by the separation member may or may not be physically separated, the component shown as a unit may or may not be a physical unit, may be located in one place or may be distributed on multiple network units. Some or all of the modules may be selected according to practical requirements to achieve the objectives of the present application. A person of ordinary skill in the art may understand and implement the embodiments of the present application without creative efforts.

The internal functional modules and examples of the structure of the risk evaluation apparatus are described above, and an actual execution body thereof may be an electronic device, including: a processor; and a memory configured to store instructions executable by the processor, wherein the processor is configured to: obtain a set of data types of data to be collected associated with a target user; obtain, from historical data of the target user collected from historical transactions, data corresponding to one or more of the data types; push, to a computing device associated with the target user, a question corresponding to a data type not obtained from the historical data; and receive an answer to the question from the computing device.

Similarly, the internal functional modules and examples of the structure of the risk evaluation apparatus are described above, and an actual execution body thereof may be an electronic device, including: obtaining a set of data types of data to be collected associated with a target user; obtaining, from historical data of the target user collected from historical transactions, data corresponding to one or more of the data types; pushing, to a computing device associated with the target user, a question corresponding to a data type not obtained from the historical data; and receiving an answer to the question from the computing device.

In the foregoing embodiments of the electronic device, the processor may be a central processing unit (CPU), or another general purpose processor, a digital signal processor (DSP), an application specific integrated circuit (ASIC), or the like. The general purpose processor may be a micro-processor, or any conventional processor, or the like. The foregoing memory may be a read-only memory (ROM), a random access memory (RAM), a flash memory, a hard disk, or a solid-state disk. The steps of the methods disclosed in the embodiments of the present application may be directly embodied as being executed by a hardware processor, or by a combination of hardware in a processor and software modules.

The embodiments of the present disclosure are described in a progressive manner. For same or similar parts in the embodiments, reference may be made to these embodiments. Each embodiment focuses on a difference from other embodiments. Especially, an electronic device embodiment is basically similar to a method embodiment, and therefore is described briefly; for related parts, reference may be made to partial descriptions in the method embodiment.

Other embodiments of this application will be apparent to those skilled in the art from consideration of the specification and practice of the present disclosure disclosed here. This application is intended to cover any variations, uses, or adaptations of this application following the general principles undisclosed in this application but have come within known or customary practice in the art. It is intended that the specification and examples be considered as exemplary only.

It will be appreciated that this application is not limited to the exact construction that has been described above and illustrated in the accompanying drawings, and that various modifications and changes can be made without departing from the scope thereof.

What is claimed is:

1. A risk evaluation method, comprising:
obtaining a set of data types of data to be collected associated with a target user;
obtaining, from historical data of the target user collected from historical transactions, data corresponding to one or more of the data types;
pushing, to a computing device associated with the target user, a question corresponding to a data type not obtained from the historical data;
receiving an answer to the question from the computing device; and
determining the obtained data and the received answer as data for risk evaluation of the target user.

2. The method according to claim 1, wherein before the obtaining, from historical data of the target user collected from historical transactions, data corresponding to one or more of the data types, the method further comprises:
determining whether the target user authorizes use of the historical data; and
the obtaining, from historical data of the target user collected from historical transactions, data corresponding to one or more of the data types comprises:
obtaining, from the historical data of the target user, the data corresponding to the one or more of the data types when the target user authorizes use of the historical data.

3. The method according to claim 2, wherein when the target user does not authorize use of the historical data, the pushing, to a computing device associated with the target user, a question corresponding to a data type not obtained from the historical data comprises:
pushing, to a computing device associated with the target user, questions corresponding to all data types in the set of data types.

4. The method according to claim 1, after the obtaining, from historical data of the target user collected from historical transactions, data corresponding to one or more of the data types, the method further comprises:
pushing the obtained data to the target user; and
the determining the obtained data and the received answer as data for risk evaluation of the target user comprises:
when receiving a confirmation that the obtained data is correct from the target user, determining the obtained data and the received answer as the data for risk evaluation of the target user.

5. The method according to claim 1, wherein:
the data types of the data to be collected comprise modifiable data and non-modifiable data; and
the target user is allowed to modify the obtained data when the obtained data belongs to the modifiable data.

6. The method according to claim 1, further comprising:
recording the received answer into the historical data of the target user.

7. The method according to claim 1, wherein the historical data comprises offline historical data.

8. A risk evaluation system, comprising one or more processors and one or more non-transitory computer-readable memories coupled to the one or more processors and configured with instructions executable by the one or more processors to cause the system to perform operations comprising:
obtaining a set of data types of data to be collected associated with a target user;
obtaining, from historical data of the target user collected from historical transactions, data corresponding to one or more of the data types;
pushing, to a computing device associated with the target user, a question corresponding to a data type not obtained from the historical data;
receiving an answer to the question from the computing device; and
determining the obtained data and the received answer as data for risk evaluation of the target user.

9. The system according to claim 8, wherein before the obtaining, from historical data of the target user collected from historical transactions, data corresponding to one or more of the data types, the method further comprises:
determining whether the target user authorizes use of the historical data; and
the obtaining, from historical data of the target user collected from historical transactions, data corresponding to one or more of the data types comprises:
obtaining, from the historical data of the target user, the data corresponding to the one or more of the data types when the target user authorizes use of the historical data.

10. The system according to claim 9, wherein when the target user does not authorize use of the historical data, the pushing, to a computing device associated with the target user, a question corresponding to a data type not obtained from the historical data comprises:
pushing, to a computing device associated with the target user, questions corresponding to all data types in the set of data types.

11. The system according to claim 8, after the obtaining, from historical data of the target user collected from historical transactions, data corresponding to one or more of the data types, the method further comprises:
pushing the obtained data to the target user; and
the determining the obtained data and the received answer as data for risk evaluation of the target user comprises:
when receiving a confirmation that the obtained data is correct from the target user, determining the obtained data and the received answer as the data for risk evaluation of the target user.

12. The system according to claim 8, wherein:
the data types of the data to be collected comprise modifiable data and non-modifiable data; and
the target user is allowed to modify the obtained data when the obtained data belongs to the modifiable data.

13. The system according to claim 8, wherein the operations further comprise:
recording the received answer into the historical data of the target user.

14. The system according to claim 8, wherein the historical data comprises offline historical data.

15. A non-transitory computer-readable storage medium for risk evaluation, the storage medium configured with instructions executable by one or more processors to cause the one or more processors to perform operations comprising:
obtaining a set of data types of data to be collected associated with a target user
obtaining, from historical data of the target user collected from historical transactions, data corresponding to one or more of the data types;
pushing, to a computing device associated with the target user, a question corresponding to a data type not obtained from the historical data;
receiving an answer to the question from the computing device; and
determining the obtained data and the received answer as data for risk evaluation of the target user.

16. The storage medium according to claim 15, wherein before the obtaining, from historical data of the target user collected from historical transactions, data corresponding to one or more of the data types, the method further comprises:
determining whether the target user authorizes use of the historical data; and
the obtaining, from historical data of the target user collected from historical transactions, data corresponding to one or more of the data types comprises:
obtaining, from the historical data of the target user, the data corresponding to the one or more of the data types when the target user authorizes use of the historical data.

17. The storage medium according to claim 16, wherein when the target user does not authorize use of the historical data, the pushing, to a computing device associated with the target user, a question corresponding to a data type not obtained from the historical data comprises:
pushing, to a computing device associated with the target user, questions corresponding to all data types in the set of data types.

18. The storage medium according to claim 15, after the obtaining, from historical data of the target user collected from historical transactions, data corresponding to one or more of the data types, the method further comprises:
pushing the obtained data to the target user; and
the determining the obtained data and the received answer as data for risk evaluation of the target user comprises:
when receiving a confirmation that the obtained data is correct from the target user, determining the obtained data and the received answer as the data for risk evaluation of the target user.

19. The storage medium according to claim 15, wherein:
the data types of the data to be collected comprise modifiable data and non-modifiable data; and
the target user is allowed to modify the obtained data when the obtained data belongs to the modifiable data.

20. The storage medium according to claim 15, wherein the operations further comprise:
recording the received answer into the historical data of the target user.
